(19) United States
(12) Patent Application Publication
(10) Pub. No.: US 2014/0209800 A1
(43) Pub. Date: Jul. 31, 2014

(54) NON-DISPERSIVE INFRARED GAS DETECTOR, AND METHOD OF STABILIZING INFRARED EMISSION OF AN INCANDESCENT LAMP

(71) Applicant: ORIENTAL SYSTEM TECHNOLOGY INC., Hsinchu (TW)

(72) Inventors: Jin-Shown SHIE, Hsinchu (TW); Chien-Hsun WANG, Hsinchu (TW)

(73) Assignee: ORIENTAL SYSTEM TECHNOLOGY INC., Hsinchu (TW)

(21) Appl. No.: 13/803,775

(22) Filed: Mar. 14, 2013

(30) Foreign Application Priority Data
Jan. 31, 2013 (TW) 102103745

(51) Int. Cl. G01N 21/61; H05B 39/04

(52) U.S. Cl. CPC G01N 21/61; H05B 39/04
USPC 250/338.4; 315/158; 250/343

(57) ABSTRACT

An NDIR gas detector includes a photodetector for detecting a portion of stray visible light emitted from an incandescent lamp so as to generate an induced electrical signal, which is compared with a preset reference signal associated with a predetermined constant level of the stray visible light corresponding to a constant temperature of the lamp so as to obtain a level difference between the induced electrical signal and the reference signal. Electrical power supplied to the lamp is repeatedly regulated based on the level difference until the induced electrical signal and the reference signal have the same level, thereby stabilizing IR emission of the lamp in response to the lamp being kept at the constant temperature.

### CROSS-REFERENCE TO RELATED APPLICATION

This application claims priority to Taiwanese Application No. 102103745, filed on Jan. 31, 2013, the contents of which are hereby incorporated by reference.

### BACKGROUND OF THE INVENTION

1. Field of the Invention

The invention relates to non-dispersive infrared (NDIR) gas detection, and more particularly to an NDIR gas detector and a method of stabilizing infrared (IR) emission of an incandescent lamp in the NDIR gas detector.

2. Description of the Related Art

The NDIR technique has been historically proven as an effective method for gas detection. A conventional NDIR gas detector includes: an IR emitter, e.g., an incandescent lamp, for generating IR radiation with continuous spectrum; an IR detector for selectively sensing the characteristic wavelength, so called the signature, of a wave radiated from a specific gas to be detected; and a gas chamber allowing the specific gas to flow between the IR emitter and the IR detector therethrough. When the specific gas is present in an optical path between the IR emitter and the IR detector, the characteristic wavelength of IR light, which is emitted along the optical path to the IR detector, is attenuated due to absorption and scatter by the specific gas, thereby reducing the intensity of an induced signal, which is generated by the IR detector and is indicated by Vₛ. Theoretically, the induced signal (Vₛ) can be expressed as follows:

Vₛ=k×S_{detector}×Iₑₘᵢₜₜₑᵣ×G(x)_{gas} (1)

Here, S_{detector} is the sensitivity of the IR detector, Iₑₘᵢₜₜₑᵣ is the intensity of the IR radiation emitted by the IR emitter, G(x)_{gas} is a single-value function related to the concentration (x) of the specific gas, and k is a calibration constant.

In practice, since a filament of the incandescent lamp keeps aging and since the temperature of the filament varies with random variation of the ambient temperature surrounding the incandescent lamp, it is hard to keep the intensity (Iₑₘᵢₜₜₑᵣ) of the IR emitter stable or constant under constant voltage or power supply. Furthermore, because blackbody radiation depends on 4^{th} to 5^{th} power of the absolute temperature of the filament according to the Stefan-Boltzmann law, instability of the intensity (Iₑₘᵢₜₜₑᵣ) of the IR emitter is amplified 4-5 times by instability of the absolute temperature of the filament. In this case, there exists a serious error inmeasuring a gas concentration if the instability of the IR intensity is not compensated during measurement.

To overcome the above problem, the conventional NDIR gas detector further includes a dummy sensor as the reference to monitor the IR intensity. The dummy sensor is totally insensitive to any gas, and is placed in proximity to the IR detector, which serves as an active sensor, to sense the IR intensity that arrives at the active sensor. It is noted that the dummy sensor and the active sensor are packaged together as a dual-element NDIR detector. A reference signal (V_{d}) induced by the dummy sensor can be expressed as follows.

V_{d}=k′×S′_{dummy}×Iₑₘᵢₜₜₑᵣ×G₀ (2)

Here, S′_{dummy} is the sensitivity of the dummy sensor, G₀ is a constant irrelevant to the concentration (x) of the specific gas to be detected, and k′ is a calibration factor of the dummy sensor. When taking Equation (2) into Equation (1), the result becomes

Vₛ=k×S_{detector}×[V_{d}/k′×S′_{dummy}×G₀]×G(x)_{gas} or

G(x)_{gas}=G₀[k′/k] [S′_{dummy}/S_{detector}] [Vₛ/V_{d}]. (3)

Since G₀, k′, k, S′_{dummy} and S_{detector} are all fixed values, G(x)_{gas} is proportional to [Vₛ/V_{d}]. Obviously, G(x)_{gas} is independent of Iₑₘᵢₜₜₑᵣ.

For example, in detecting CO₂ gas, an IR detector aiming at a narrow wavelength band of 4.26 μm is used as the active sensor, and an optical sensor aiming at a wavelength band of 3.1 μm˜3.96 μm is used as the dummy sensor.

However, fabrication of such dual-element NDIR detector with an additional dummy sensor is relatively complicated and has relatively higher cost, because two costly narrowband IR filters, which are respectively placed in front of the active sensor and the dummy sensor and are formed by special multi-layer coatings of specific materials, are required to screen out unwanted wavelengths.

### SUMMARY OF THE INVENTION

Therefore, an object of the present invention is to provide an NDIR gas detector, and a method of stabilizing IR emission of an incandescent lamp in the NDIR gas detector that can overcome the aforesaid drawbacks of the prior art.

According to one aspect of the present invention, there is provided a method of stabilizing IR emission of an incandescent lamp. The incandescent lamp has an incandescent filament and is capable of emitting IR radiation with a continuous spectrum. The method of this invention comprises the steps of:

a) configuring a photodetector located in proximity of the incandescent lamp to detect a portion of stray visible light emitted from the incandescent lamp so as to generate an induced electrical signal corresponding to the stray visible light detected by the photodetector;

b) configuring an electronic control unit to compare the induced electrical signal generated in step a) with a preset reference signal so as to obtain a level difference between the induced electrical signal and the preset reference signal, the preset reference signal being associated with a predetermined constant level of the stray visible light corresponding to a constant temperature of the incandescent filament;

c) configuring a power unit to regulate electrical power supplied to the incandescent lamp based on the level difference obtained in step b); and

d) repeating steps a) to c) until the induced electrical signal and the preset reference signal have the same level such that IR emission of the incandescent lamp is stable in response to the incandescent filament being kept at the constant temperature.

According to another aspect of the present invention, an NDIR gas detector comprises an incandescent lamp, an IR detector, a gas chamber, a photodetector, an electronic control unit, and a power unit.

The incandescent lamp has an incandescent filament, and is capable of emitting IR radiation with a continuous spectrum.

The IR detector is operative to selectively sense the characteristic wavelength of a wave radiated from a specific gas to be detected.

The gas chamber allows the specific gas to flow between the incandescent lamp and the IR detector therethrough.

The photodetector is located in proximity of the incandescent lamp to detect a portion of stray visible light emitted from the incandescent lamp so as to generate an induced electrical signal corresponding to the stray visible light detected by the photodetector.

The electronic control unit is connected electrically to the photodetector for receiving the induced electrical signal therefrom, and compares the induced electrical signal with a preset reference signal so as to generate a feedback control signal indicative of a level difference between the induced electrical signal and the preset reference signal. The preset reference signal is associated with a predetermined constant level of the stray visible light corresponding to a constant temperature of the incandescent filament.

The power unit is connected electrically to the electronic control unit and the incandescent lamp. The power unit is operative to repeatedly regulate electrical power supplied to the incandescent lamp based on the feedback control signal from the electronic control unit until the induced electrical signal and the preset reference signal have the same level.

When the induced electrical signal and the preset reference signal have the same level, IR emission of the incandescent lamp is stable in response to the incandescent filament being kept at the constant temperature.

### BRIEF DESCRIPTION OF THE DRAWINGS

Other features and advantages of the present invention will become apparent in the fol lowing detailed description of the preferred embodiment with reference to the accompanying drawings, of which:

FIG. 1 is a schematic block diagram illustrating a preferred embodiment of an NDIR gas detector according to the present invention;

FIG. 2 is a schematic diagram illustrating the principle of NDIR gas detection of the present invention; FIG. 3a illustrates blackbody radiation spectra of an incandescent lamp at 700° K and 1000° K, respectively, according to Planck's law; and

FIG. 3b is a plot of FIG. 3a in log scale.

### DETAILED DESCRIPTION OF THE PREFERRED EMBODIMENT

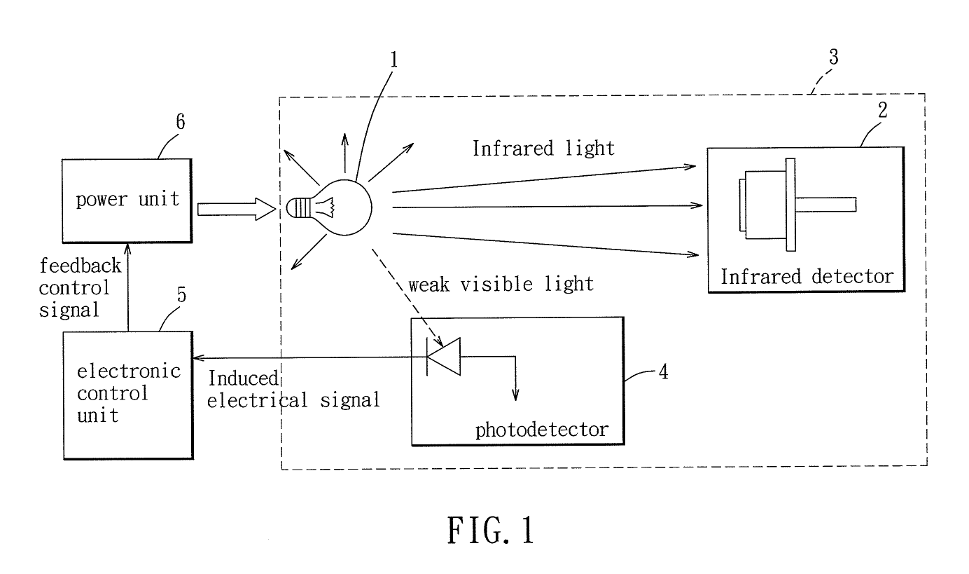

Referring to FIG. 1, the preferred embodiment of an NDIR gas detector according to the present invention is shown to include an incandescent lamp 1, an IR detector 2, a gas chamber 3, a photodetector 4, an electronic control unit 5, and a power unit 6.

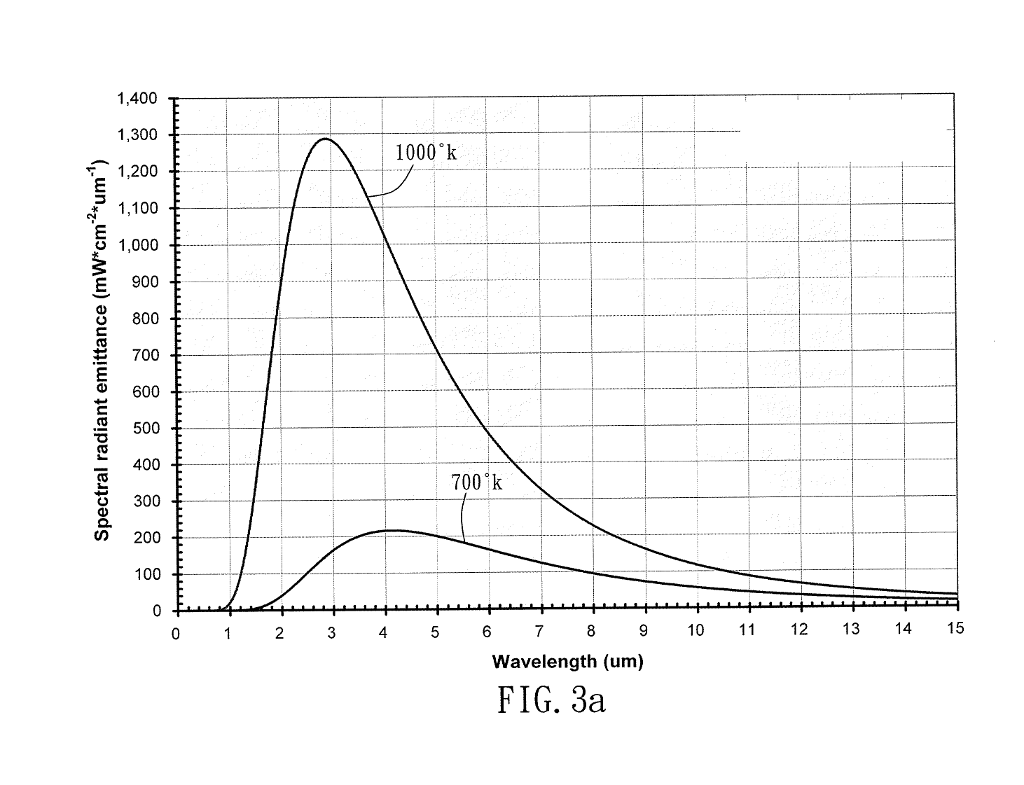

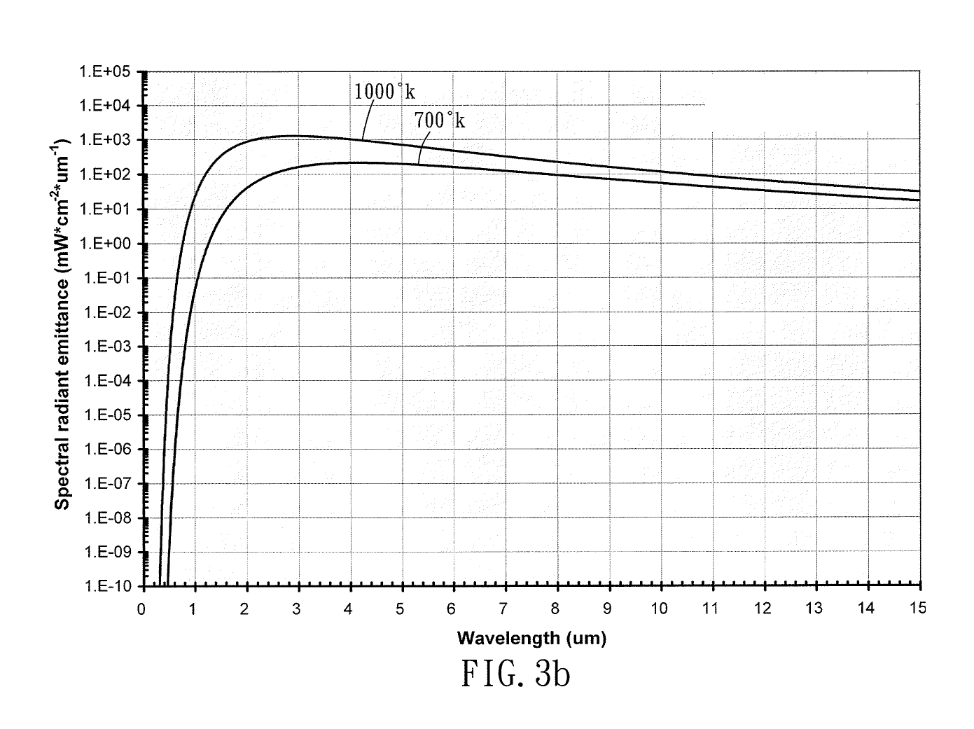

The incandescent lamp 1 serves as an IR emitter for NDIR gas detection. The incandescent lamp 1 has a resistive incandescent filament capable of being heated electrically to emit IR radiation with a continuous spectrum that is a wide-range radiation spectrum covering various IR signatures of gases of interest. The continuous radiation spectrum is a blackbody-like spectrum (see FIG. 3a) based on Planck's radiation formula expressed as follows.

W(λ)=c₁/{⁵[exp(c₂/λT)−1]}(Watt/cm²/μm) (4)

Here, c₁ is a first radiation constant equal to 37415 W/cm²/μm⁴, and c₂ is a second radiation constant equal to 14388 μm/K. According to Wien's displacement law, the continuous radiation spectrum has a peak wavelength (λₘ) at a temperature (T), wherein the relationship between the peak wavelength (λₘ) and the temperature (T) is expressed as follows.

T×λₘ=2898(K−μm) (5)

Namely, the product of the absolute temperature of the incandescent filament of the incandescent lamp 1 and the peak wavelength of the IR radiation is a constant. For example, to produce a peak wavelength at 4 μm for detection of CO₂ gas, the incandescent filament should be heated up to about 700° K (i.e., 427° C.) for maximum emission efficiency based on Equation (5). As shown in FIG. 3a, at such temperature, extremely weak light is generated near a visible range in comparison to that generated at 4 μm-wavelength, according to Planck's radiation law. The weak radiation in visible wavelength is amplified in log scale, as shown in FIG. 3b. Nevertheless, the shape of the radiation spectrum is fixed if the temperature of the incandescent filament is precisely kept constant. In other words, if light intensity generated in a visible wavelength is kept constant precisely, the temperature of the incandescent filament is also constant such that the intensities of all other wavelengths including the infrared to be used are kept constant.

The IR detector 2 selectively senses the characteristic wavelength of a wave radiated from a specific gas to be detected, e.g., 4 μm-wavelength of the wave radiated from CO₂ gas. In this embodiment, the characteristic wavelength of the wave sensed by the IR detector 2 is within a wavelength range from 1.2 μm up to 50 μm to which a silicon photodiode is virtually insensitive.

The gas chamber 3 houses the incandescent lamp 1 and the IR detector 2 for allowing the specific gas to flow between the incandescent lamp 1 and the IR detector 2.

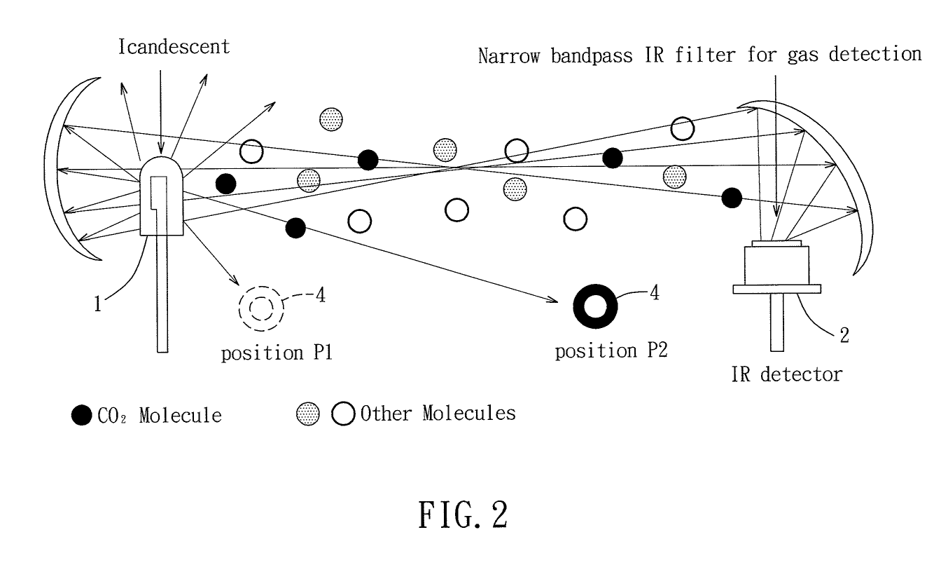

The photodetector 4 is received in the gas chamber 3, and is located in proximity of the incandescent lamp 1 to detect a minute fraction of stray visible light emitted from the incandescent lamp 1 so as to generate an induced electrical signal corresponding to the stray visible light detected by the photodetector 4. The photodetector 4 can be located at a position (P1) close to the incandescent lamp 1 or another position (P2) close to the IR detector 2, as shown in FIG. 2. However, the photodetector 4 is preferably disposed as close as possible to the IR detector 2 such that it reveals closely the exact IR radiation quantity entering the IR detector 2. In this embodiment, the photodetector 4 is a silicon-based photodetector, such as a silicon photodiode. The visible light emitted from the incandescent lamp 1 and detected by the photodetector 4 has a cutoff wavelength of up to 1.1 μm. As commonly known, a silicon photodiode is inexpensive, and is an ultra-sensitive and fast-response device over its governing spectrum compared to the dummy sensor of the prior art, and thus, is able to detect extremely lower levels of light signal. Furthermore, a silicon photodiode of tenths of square-millimeter areas is able to induce sufficient photocurrent of micro-amp magnitude, even when the silicon photodiode receives only 1 millionth of the visible light emitted from a miniaturized milliwatt IR lamp. This means, if the photodetector 4 is placed close to the incandescent lamp 1, the photodetector 4 still can provide a photo-induced signal as a feedback signal to precisely control the incandescent lamp 1 at constant filament temperature and constant IR emission intensity, which is useful for NDIR gas detection described in this invention. In other embodiments, the photodetector 4 can be one of a photodiode, a photo-transistor, a photoconductor and a Schottky photodiode that are of GaAs, InGaAs, Ge or Si—Ge type. The Schottky photodiode is fabricated on a silicon wafer.

The electronic control unit 5 is connected electrically to the photodetector 4 for receiving the induced electrical signal therefrom. The electronic control unit 5 compares the induced electrical signal with a preset reference signal so as to generate a feedback control signal indicative of a level difference between the induced electrical signal and the preset reference signal. The preset reference signal is associated with a predetermined constant level of the stray visible light corresponding to a constant temperature of the incandescent filament.

The power unit 6 is connected electrically to the electronic control unit 5 and the incandescent lamp 1. The power unit 6 is operative to repeatedly regulate electrical power supplied to the incandescent lamp 1 based on the feedback control signal from the electronic control unit 5 until the induced electrical signal and the preset reference signal have the same level. When the induced electrical signal and the preset reference signal have the same level, the incandescent filament is kept at the constant temperature such that stable IR emission (i.e., constant IR emission intensity) of the incandescent lamp 1 is obtained, regardless of incandescent filament aging and ambient temperature variation.

To sum up, because of the ultra high sensitivity and fast response speed of the silicon photodetector 4, feedback control of constant-filament-temperature can be conducted with extremely high precision. In addition, due to this high sensitivity, the location of the silicon photodetector 4 is not critical. It is noted that the silicon photodetector 4 has to be mounted outside the IR detector 2 because a narrowband IR window on a package (not shown) of the IR detector 2 screens away all incident light except the signature IR wavelength to be detected. Therefore, due to the presence of the silicon photodetector 4, which can be regarded as a substitute for the dummy sensor of the aforesaid dual-element NDIR detector, the NDIR gas detector of the present invention can be fabricated with less complexity at relatively lower costs compared to the prior art with the dual-element NDIR detector.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method of stabilizing infrared (IR) emission of an incandescent lamp, the incandescent lamp having an incandescent filament and being capable of emitting IR radiation with a continuous spectrum, said method comprising the steps of:
a) configuring a photodetector located in proximity of the incandescent lamp to detect a portion of stray visible light emitted from the incandescent lamp so as to generate an induced electrical signal corresponding to the stray visible light detected by the photodetector;
b) configuring an electronic control unit to compare the induced electrical signal generated in step a) with a preset reference signal so as to obtain a level difference between the induced electrical signal and the preset reference signal, the preset reference signal being associated with a predetermined constant level of the stray visible light corresponding to a constant temperature of the incandescent filament;
c) configuring a power unit to regulate electrical power supplied to the incandescent lamp based on the level difference obtained in step b); and
d) repeating steps a) to c) until the induced electrical signal and the preset reference signal have the same level such that IR emission of said incandescent lamp is stable in response to the incandescent filament being kept at the constant temperature.

2. The method as claimed in claim 1, wherein the photodetector includes one of a photodiode, a photo-transistor, a photoconductor, and a Schottky photodiode.

3. The method as claimed in claim 2, wherein the Schottky photodiode is fabricated on a silicon wafer.

4. The method as claimed in claim 2, wherein each of the photodiode, the photoconductor and the schottky photodiode is of GaAs, InGaAs, Ge or Si—Ge type.

5. The method as claimed in claim 1, wherein the stray visible light detected by the photodetector in step a) has a cutoff wavelength of up to 1.1 μm.

6. A non-dispersive infrared (NDIR) gas detector comprising:
an incandescent lamp having an incandescent filament and capable of emitting IR radiation with a continuous spectrum;
an IR detector for selectively sensing the characteristic wavelength of a wave radiated from a specific gas to be detected;
a gas chamber for allowing the specific gas to flow between said incandescent lamp and said IR detector therethrough;
a photodetector located in proximity of said incandescent lamp to detect a portion of stray visible light emitted from said incandescent lamp so as to generate an induced electrical signal corresponding to the stray visible light detected by said photodetector;
an electronic control unit connected electrically to said photodetector for receiving the induced electrical signal therefrom, and comparing the induced electrical signal with a preset reference signal so as to generate a feedback control signal indicative of a level difference between the induced electrical signal and the preset reference signal, the preset reference signal being associated with a predetermined constant level of the stray visible light corresponding to a constant temperature of said incandescent filament; and
a power unit connected electrically to said electronic control unit and said incandescent lamp, said power unit being operative to repeatedly regulate electrical power supplied to said incandescent lamp based on the feedback control signal from said electronic control unit until the induced electrical signal and the preset reference signal have the same level;
wherein, when the induced electrical signal and the preset reference signal have the same level, IR emission of said incandescent lamp is stable in response to said incandescent filament being kept at the constant temperature.

7. The NDIR gas detector as claimed in claim 6, wherein said photodetector is disposed as close as possible to said IR detector.

8. The NDIR gas detector as claimed in claim 6, wherein the characteristic wavelength sensed by said IR detector is within a wavelength range from 1.2 μm to 50 μm.

9. The NDIR gas detector as claimed in claim 8, wherein the stray visible light detected by said photodetector has a cutoff wavelength of up to 1.1 μm.

10. The NDIR gas detector as claimed in claim 6, wherein said photodetector includes one of a photodiode, a photo-transistor, a photoconductor, and a Schottky photodiode.

11. The NDIR gas detector as claimed in claim 10, wherein said Schottky photodiode is fabricated on a silicon wafer.

12. The NDIR gas detector as claimed in claim 10, wherein each of said photodiode, said photoconductor and said schottky photodiode is of GaAs, InGaAs, Ge or Si—Ge type.
